(19) United States
(12) Patent Application Publication
(10) Pub. No.: US 2024/0249858 A1
(43) Pub. Date: Jul. 25, 2024

(54) FLAME-RETARDANT CABLE AND USES THEREOF

(71) Applicant: M. Holland Company, Northbrook, IL (US)

(72) Inventor: Paul P. Lorigan, Easton, PA (US)

(21) Appl. No.: 18/496,691

(22) Filed: Oct. 27, 2023

Related U.S. Application Data
(60) Provisional application No. 63/481,302, filed on Jan. 24, 2023.

(51) Int. Cl. H01B 7/295; C08L 27/12; C08L 27/18; C08L 27/20; H01B 3/44

(52) U.S. Cl. CPC H01B 7/295; C08L 27/12; C08L 27/18; C08L 27/20; H01B 3/445; C08L 2201/02; C08L 2203/20

(57) ABSTRACT

A novel flame retardant cable comprising a protective insulative layer comprising one or more fluoropolymers or a reaction product of one or more fluoropolymers.

### CROSS-REFERENCE TO RELATED APPLICATIONS

This application claims priority to U.S. Provisional Application No. 62/719,459, filed Aug. 17, 2018, the contents of which is fully incorporated herein by reference.

### FIELD OF THE INVENTION

The present disclosure relates generally a novel flame-retardant cable comprising one or more fluoropolymer compounds, which is particularly suitable for use as electrical transmission and/or distribution cables in areas at risk for wildfires. In particular, the disclosure relates to a coating or cabling design for high-voltage, electric power transmission systems.

### BACKGROUND

Electrical transmission and distribution cables are ubiquitous in modern society and are typically exposed to the elements for prolonged periods of time. In high wind conditions, exposed bare high voltage cables can gallop and touch—sending sparks onto the underlying brush and igniting flammable material below. This phenomenon is particularly dangerous in remote or rural areas where the sparks can ignite wildfires. To mitigate this risk of wildfires, one solution has been to bury electrical wires. However, such an approach is expensive and not practicable in some areas. Another solution has been to wrap cables with insulative material(s). These “covered cables” are jacketed with crosslinked high density polyethylene (HDPE). However, these “covered cables” are difficult to manufacture and can exhibit deleterious performance related to various factors, including track resistance absent additives, sunlight resistance absent additives, and others. Moreover, these “covered cables” fail rigorous flame testing, such as the flame test proscribed in the Steiner Tunnel Test ASTM E84 UL 723 due to the flammable nature of polyethylene.

Accordingly, there is a need or desire for easy to manufacture insulated cables that avoid the performance issues associated with HDPE coverings and can withstand rigorous flame testing.

### SUMMARY

The present disclosure relates to a flame-retardant cable comprising an inner conductive electrical cable (i.e., a conductor or conductive element) and an insulative layer encasing or encompassing the inner conductive electrical cable, where the insulative layer comprises one or more fluoropolymers or a reaction product thereof.

The one or more fluoropolymers of the insulative layer may be fluorinated ethylene propylene (FEP), polyvinylidene fluoride (PVDF), perfluoro alkoxy alkane (PFA) and ethylene tetrafluoroethylene (ETFE); or a combination thereof.

In further embodiments, the insulative layer may comprise a reaction product of fluorinated ethylene propylene (FEP), polyvinylidene fluoride (PVDF), perfluoro alkoxy alkane (PFA) and ethylene tetrafluoroethylene (ETFE); or a combination thereof.

In still further embodiments, the insulative layer may lack UV additives, tracking additives, or both.

The present flame-retardant cable may be manufactured by a cross-linking process.

In preferred embodiments, the present flame-retardant cable has physical properties that are suitable for electrical power transmission and/or distribution. Such physical properties include the capability of passing the Steiner Tunnel Test (ASTM E84 UL 723) and/or passing the Inclined Plane Tracking and Erosion Test (ASTM D 2303). Further, in preferred embodiments, the present flame-retardant cable retains greater than 75% of physical properties after 1,000 hours of sunlight exposure as measured in a Xenon Arc Weather-o-meter.

The present flame-retardant cable may further comprise a semiconductor layer disposed in between the inner conductive cable and the insulative layer. In embodiments, the semi-conductive layer encases the inner conductive cable and is encased by the insulative layer. In further embodiments, the semi-conductive layer contacts and encases the inner conductive layer. In still further embodiments, the insulative layer contacts and encases the semiconductive layer. The semiconductor layer may comprise one or more fluoropolymers or a reaction product thereof.

### BRIEF DESCRIPTION OF DRAWINGS

FIG. 1 illustrates an embodiment of the present disclosure at a perspective view.

FIG. 2 illustrates an embodiment of the present disclosure without a semiconductive layer in a cross-sectional view.

FIG. 3 illustrates an embodiment of the present disclosure with a semiconductive layer in a cross-sectional view.

FIG. 4 illustrates an embodiment of the present disclosure assembled in perspective view.

FIG. 5 illustrates another embodiment of the present disclosure assembled in perspective view.

FIG. 6 illustrates an embodiment of the present disclosure at a perspective view.

### DETAILED DESCRIPTION

As used herein, “tracking additives” are additives that are typically added to insulative layers to improve the tracking performance of a conductive cable, particularly conductive cables used in high-voltage, electric power and/or distribution transmission systems. Exemplary tracking additives include UV light absorbers (such as Benzophenones, Benzotriazoles, Cyanoacrylates, Carbon black, Hydroxybenzophenones, Hydroxyphenyl Benzotriazoles, Rutile titanium oxide, Oxanilides, Benzotriazoles, Hydroxyphenyl Triazines, 2-[2-hydroxy-3,5-di-(1,1-dimethylbenzyl)]-2H-benzotriazole, 2-Hydroxy-4-n-Octoxybenzophenone, 2-(3′-tert-butyl-2′-hydroxy-5′-methylphenyl)-5-chlorobenzotriazole, 2-(2H-Benzotriazole-2-yl)-4-methylphenyl, Etocrilene, Octocrilene, and titanium dioxide) and organic siloxanes.

As used herein, “UV additives” are ultraviolet additives that are typically added to insulative layers to combat the adverse effects associated with prolonged sunlight exposure. Exemplary UV additives include hindered amine light stabilizers (such as Poly[6-[(1,1,3,3-tetramethylbutyl)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]]), 1,6-Hexanediamine, N,N′-bis(2,2,6,6-tetramethyl-4-piperidinyl)-polymer with 2,4,6-trichloro-1,3,5-triazine, reaction products of N-butyl-1-butanamine and N-butyl-2,2,6,6-tetramethyl-4-piperidinamine) and UV absorbers (such as 2-[2-hydroxy-3,5-di-(1,1-dimethylbenzyl)]-2H-benzotriazole, 2-Hydroxy-4-n-Octoxybenzophenone, 2-(3′-tert-butyl-2′-hydroxy-5′-methylphenyl)-5-chlorobenzotriazole, 2-(2H-Benzotriazole-2-yl)-4-methylphenyl, Etocrilene, Octocrilene, and titanium dioxide).

As used herein, “fluoropolymer” is a chemical entity comprising a hydrocarbon chain, typically comprising C2 monomers, substituted with fluorine and/or fluorine-containing groups (e.g., —CF₃ and —OCF₃).

As used herein “about” refers to a variance of 10%. Thus, “about 10” is inclusive of a range from 9 to 11.

The present disclosure describes a flame retardant cable comprising an insulative layer comprising one or more fluoropolymers or a reaction product of one or more fluoropolymers.

The flame retardant cable comprises a conductor and at least one insulative layer comprising one or more fluoropolymers or a reaction product of one or more fluoropolymers. In preferred embodiments, the insulative layer consists of only one or more fluoropolymers or a reaction product of one or more fluoropolymers.

Skilled artisans would also readily appreciate what constitutes a fluoropolymer and would understand that a fluoropolymer comprises a hydrocarbon chain (e.g., alkyl or alkylene chain) substituted with fluorine and/or fluorine-containing groups (e.g., —CF₃ and —OCF₃). A skilled artisan would further readily appreciate that a reaction product of more than one fluoropolymer would result in a heterogenous mixture of conjugated fluoropolymers. A skilled artisan would understand the conditions and procedures required to generate a reaction product of one or more fluoropolymers. Exemplary fluoropolymers suitable for use in the insulative layer include, but are not limited to, fluorinated ethylene propylene (FEP), polyvinylidene fluoride (PVDF), perfluoro alkoxy alkane (PFA) and ethylene tetrafluoroethylene (ETFE). Exemplary reaction products of one or more fluoropolymers include a co-polymer of tetrafluoroethylene and hexafluoropropylene and a terpolymer of tetrafluoroethylene hexafluoropropylene and Perfluoropropylvinyl Ether.

In some embodiments, the insulative layer does not contain additives typically found in insulated cables designed for use in electrical power transmission and/or distribution. In one embodiment, the insulative layer may lack tracking additives. In a further embodiment, the insulative layer may lack UV additives. The avoidance of UV additives are particularly suitable for embodiments where the insulative layer comprising one or more fluoropolymers or a reaction product of one or more fluoropolymers is translucent and/or not opaque. As a yet further embodiment, the insulative layer may lack tracking additives and UV additives.

Despite the lack of UV additives, the present flame retardant cable may retain greater than 75% of its physical properties following one thousand (1,000) hours of sunlight exposure where the physical properties comprise tensile strength and elongation. In other embodiments, the present flame retardant cable retains greater than 90% of its physical properties following one thousand (1,000) hours of sunlight exposure. In preferred embodiments, the present flame retardant cable retains greater than 95% or greater than 99% of its physical properties following one thousand (1,000) hours of sunlight exposure.

The insulative layer may comprise or only consist of recyclable material or materials. The insulative layer may also avoid the need for crosslinking, even as the conductive element reaches a high temperature (e.g., 200° C.).

In certain embodiments, the flame retardant cable further comprises a semiconductor layer disposed between the conductor and the insulative layer. A semiconductor layer is preferred when the voltage through the conductor is expected to approach 35 KV.

The semiconductor layer may contain one or more fluoropolymers. Exemplary fluoropolymers of the semiconductor layer include fluorinated ethylene propylene (FEP), polyvinylidene fluoride (PVDF), perfluoro alkoxy alkane (PFA) and ethylene tetrafluoroethylene (ETFE). The semiconductor layer comprises one or more conductive compounds known to those skilled in the art. An exemplary conductive compound is conductive carbon black. The one or more semiconductive compounds comprise about 5 to about 50%, 5 to 50%, about 5 to about 35%, 5 to 35%, about 10 to about 30%, 10 to 30%, about 15% to about 25%, or 15 to 25% of the total weight of the semiconductive layer. The semiconductor layer may further comprise one or more antioxidants known to those skilled in the art, including pentaerythritol tetrakis(3-(3,5-di-tert-butyl-4-hydroxyphenyl)propionate) (such as Irganox® 1010), 3,5-Bis(1,1-dimethylethyl)-4-hydroxybenzenepropanoic acid thiodi-2,1-ethanediyl ester (such as Irganox® 1035), thioesters (such as BNX® DSTDP and DLTDP), zinc 2-mercaptotoluimidazole, zinc di(benzimidazol-2-yl) disulphide, and other antioxidants known to those skilled in the art. When present, the semiconductor layer may comprise about 1 to about 5%, 1 to 5%, about 1 to about 3%, 1 to 3%, about 1 to about 2%, 1 to 2%, or about 2% of the total weight of the semiconductive layer.

The conductor, also referred to as a conductive element and inner conductive element herein, is any metal conductive element and is the spatially central component of the present flame retardant cable. In embodiments, the conductor is the standard conductive element in high-voltage electric power transmission/distribution systems. In preferred embodiments, the conductor can tolerate voltages at least 65,000 (e.g., 69,000) volts or greater than 100,000 volts.

In some embodiments, the present insulative cable may comprise a jacket. A jacket is most preferred in embodiments comprising a semiconductive layer. The jacket may comprise polyethylene, including crosslinked high density polyethylene (HDPE).

The figures of the present disclosure are meant to illustrate the inventive flame retardant cable and are not intended to be limiting. For example, the relative size, size and shape of the conductor and various layers may vary. In preferred embodiments, the width/thickness of the insulative layer is greater than the width/thickness of the semiconductor layer.

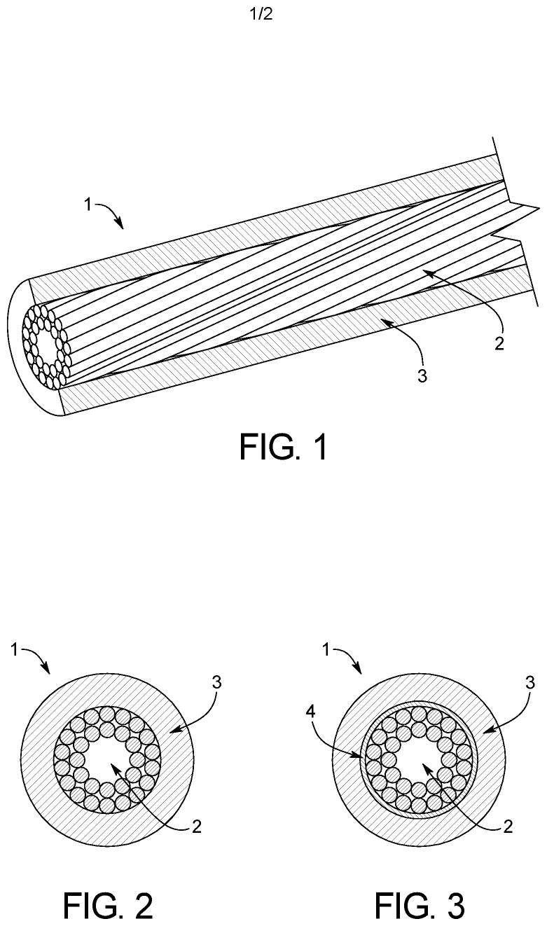

FIG. 1 describes an embodiment of the present disclosure viewed from a perspective angle. In this embodiment, the flame retardant cable 1 comprises a conductor 2 and an insulative layer 3. FIG. 1 shows that the insulative layer 3 may be translucent where the conductor 2 is visible.

FIG. 2 describes an embodiment of the present disclosure in a cross-sectional view where the flame retardant cable 1 comprises a conductor 2, and an insulative layer 3.

FIG. 3 describes an embodiment of the present disclosure in a cross-sectional view where the flame retardant cable 1 comprises a conductor 2, and an insulative layer 3 and a semiconductive layer 4.

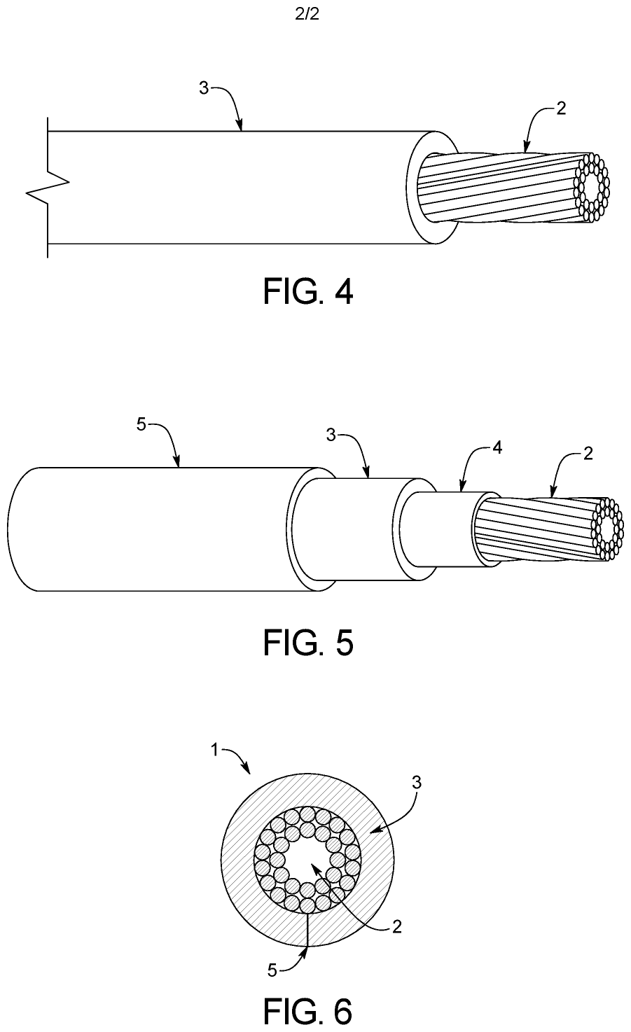

FIG. 4 depicts an embodiment of the present disclosure where the conductor 1 is encased by an insulative layer 3.

FIG. 5 depicts an embodiment of the present disclosure where the conductor 2 is encased by a semiconductive layer 4, which is encased by an insulative layer 3, which is encased in a jacket 5.

FIG. 6 depicts an embodiment of the present disclosure where the conductor 2 is encased by an insulative layer 3 comprising a slit 5.

### Methods of Manufacturing the Present Flame Retardant Cable

One of the benefits of the present flame retardant cable is the ease of manufacturing. Embodiments of the present flame retardant cable can be made with standard thermal plastic extrusion processes known to those skilled in the art. In this way, cross-linking and post-processing steps (e.g., extended cure times) may be avoided.

The present flame retardant cable can be made by extruding a single layer of FEP over a conductor (e.g., an aluminum or copper conductor) or a conductor encased with a semiconductive layer

As will be understood by those skilled in the art, the following protocol for constructing an embodiment of the present disclosure represents an improvement over the Monosil Process typically employed for the manufacture of prior art cables.

By way of illustration, the following procedure can be utilized to manufacture an insulative layer comprising FEP. One skilled in the art would be able to modify the following procedure to manufacture an insulative layer comprising a different fluoropolymer, a reaction product of one or more fluoropolymers, or a mixture thereof. Further, carbon black or other semiconductive components can be added to the following procedure to manufacture a semiconductive layer comprising one or more fluoropolymers and one or more semiconductive components.

The extrusion, tooling and molding machines used for FEP should be constructed of high nickel alloy corrosion-resistant materials and capable of operating at temperatures up to 400° C. (750ºF). FEP may be applied as a wire insulation and cable jacket using tubing techniques and Draw-Down Ratios (DDR) generally ranging from 30:1 to 80:1. Higher DDRs usually allow for greater line speed. A draw-ratio balance (DRB) ranging from 0.9 to 1.1 is preferred. A controlled vacuum at the rear of the crosshead may adjust the melt cone to the desired length. A melt cone that is too long results in excessive variations while a melt cone that is too short result in excessive spark failures and cone breaks. An electric wire preheater located close to the crosshead is preferred for preheating the wire. The coated wire should pass through an air gap followed by a warm-water quench at (110 ºF to 150 ºF) to allow uniform cooling and prevent the formation of shrinkage voids in the insulative layer. The cooling procedures will vary based on the thickness of the insulative layer.

One skilled in the art would appreciate that extruding FEP is temperature dependent. In preferred embodiments, temperature gradients are used on a zone-basis to manufacture an insulative layer comprising FEP. For example, the extrusion process may utilize temperatures ranging from about 349° ° C. to about 404° C. across different zones. Exemplary temperatures per zone are provided in Table 1 for a 60 mm extruder with a 30:1 L/D.

TABLE 1

| Zone | Temperature (° C.) |
|---|---|
| Rear Zone 2 | 349 |
| Rear Center 2 | 371 |
| Center | 390 |
| Front Center | 395 |
| Front | 399 |
| Clamp | 404 |
| Adapter | 404 |
| Crosshead | 404 |
| Die Holder | 404 |
| Melt | 399 |

In embodiments where a semiconductor layer is present, present flame retardant cable can be made by first extruding a FEP based semiconductive compound over a conductor (e.g., an aluminum or copper conductor) and then extruding a FEP insulation layer over the semiconductive layer. This construction may also have a polyethylene jacket over the FEP insulation. The semiconductive layer in these embodiments comprise FEP and conductive carbon black.

Alternatively, the insulative layer with or without the semiconductor layer may be applied to a conductor. For example, the insulative layer may be wrapped around a conductor. In an alternate example, the insulative layer may encompass the conductor by introducing a slit in the insulative layer to allow the conductor access to the central channel formed by the insulative layer. Although a slit is exemplified in FIG. 6, the present inventor further contemplates alternative means to allow the conductor to access the internal channel of the insulative layer. In these embodiments, existing conductors may be retrofitted with the disclosed insulative layer, including in situ conductors.

As will be appreciated by those skilled in the art, the present extrusion methods are a significant improvement over the prior art methods of assembling an insulative layer around a central conductor.

### Example 1

Steiner Tunnel Testing. The flame-retardant composition of the present disclosure is subjected to the protocol defined in ASTM E84 UL 723, which is hereby incorporated by reference in its entirety. In brief, twenty four (24) feet of cabling is subjected to three hundred thousand (300,000) BTUs for twenty (20) minutes with an airflow of 1.2 m/s. Established metrics for burn length and smoke density dictate whether a cable sample passes. The cable must burn less than five (5) feet and the smoke density index must not exceed a peak of 450. Red Oak is used as the calibration standard for smoke, having a smoke index of 100. Surprisingly, the flame-retardant composition of the present disclosure passes this severe flame test. As would be appreciated by those skilled in the art, prior art polyethylene-coated cable fails this test as polyethylene is flammable.

### Example 2

Track Resistance Testing. The flame-retardant cables of the present disclosure were subjected to the protocol defined in ASTM D 2303, which is hereby incorporated by reference in its entirety. As noted in Tables 2 and 3, the voltage and contaminant flows varied. FEP 6 comprises perfluoro co-polymer of tetrafluoroethylene and hexafluoropropylene with a melt flow rate ranging from 8 to 10 dg/min. FEP 9SC comprises a terpolymer of tetrafluoroethylene hexafluoropropylene and Perfluoropropylvinyl Ether with a melt flow rate ranging from 8 to 10 dg/min. Neither FEP 6 nor FEP 9SC contained tracking additives in the insulative layer.

TABLE 2
Voltage: 2500 V
Contaminant Flow: 0.15 ml/min

| | FEP | FEP | FEP | FEP | FEP | FEP |
|---|---|---|---|---|---|---|
| Sample | 6 | 6 | 6 | 9SC | 9SC | 9SC |
| Tracking Length (mm) | 0 | 0 | 0 | 0 | 0 | 0 |
| Tracking Depth (mm) | 0 | 0 | 0 | 0 | 0 | 0 |
| Test Time (hrs) | 15 | 15 | 15 | 15 | 15 | 15 |

TABLE 3
Voltage: 3500 V
Contaminant Flow: 0.30 ml/min

| | FEP | FEP | FEP | FEP | FEP | FEP |
|---|---|---|---|---|---|---|
| Sample | 6 | 6 | 6 | 9SC | 9SC | 9SC |
| Tracking Length (mm) | 0 | 0 | 0 | 0 | 0 | 0 |
| Tracking Depth (mm) | 0 | 0 | 0 | 0 | 0 | 0 |
| Test Time (hrs) | 15 | 15 | 15 | 15 | 15 | 15 |

Surprisingly, the flame-retardant cables of the present disclosure passed this test, including embodiments were the flame-retardant composition lacked tracking additives

### Example 3

Sunlight Resistance Testing. The flame-retardant composition of the present disclosure was subjected to simulated sunlight exposure for one thousand (1,000) hours and deterioration was measured by a Xenon Arc Weather-o-meter. Table 4 reflects certain physical properties of embodiments of the present disclosure prior to sunlight exposure. Table 5 reflects how the sunlight impacted those properties.

TABLE 4

| | FEP 6 | FEP 9 |
|---|---|---|
| Tensile Strength psi | 3626 | 3832 |
| Elongation, % | 390 | 396 |

TABLE 5

| | FEP 6 | FEP 9 |
|---|---|---|
| Tensile Retained % | 99 | 89 |
| Elongation Retained % | 103 | 91 |

Surprisingly, both embodiments of the flame-retardant cables of the present disclosure showed excellent retention of physical properties (e.g., tensile and elongation), including embodiments were the flame-retardant composition lacked UV additives.

Obviously, many variations and modifications of the present invention are possible in light of the above teachings. It is therefore to be understood that within the scope of the appended claims, the present invention may be practiced otherwise than as specifically described herein.

We claim:

1. A flame-retardant cable comprising:
an inner conductive electrical cable;
an insulative layer encompassing the inner conductive electrical wire;
wherein the insulative layer comprises one or more fluoropolymers or a reaction product thereof.

2. The flame-retardant cable of claim 1, wherein the one or more fluoropolymers are selected from the group consisting of: fluorinated ethylene propylene (FEP), polyvinylidene fluoride (PVDF), perfluoro alkoxy alkane (PFA) and ethylene tetrafluoroethylene (ETFE); or a combination thereof.

3. The flame-retardant cable of claim 2, wherein the one or more fluoropolymers comprises fluorinated ethylene propylene (FEP).

4. The flame-retardant cable of claim 2, wherein the one or more fluoropolymers comprises ethylene tetrafluoroethylene (ETFE).

5. The flame-retardant cable of claim 1, wherein the one or more fluoropolymers or a reaction product thereof is a reaction product of one or more fluoropolymers selected from the group consisting of: fluorinated ethylene propylene (FEP), polyvinylidene fluoride (PVDF), perfluoro alkoxy alkane (PFA) and ethylene tetrafluoroethylene (ETFE); or a combination thereof.

6. The flame-retardant cable of claim 5, wherein the reaction product comprises a reaction of fluorinated ethylene propylene (FEP).

7. The flame-retardant cable of claim 5, wherein the reaction product comprises a reaction of polyvinylidene fluoride (PVDF).

8. The flame-retardant cable of claim 5, wherein the reaction product comprises a reaction of perfluoro alkoxy alkane (PFA).

9. The flame-retardant cable of claim 1, wherein the flame-retardant cable does not contain UV additives.

10. The flame-retardant cable of claim 1, wherein the flame-retardant cable does not contain tracking additives.

11. The flame-retardant cable of claim 1, capable of passing the Steiner Tunnel Test, ASTM E84 UL 723.

12. The flame-retardant cable of claim 1, capable of passing the Inclined Plane Tracking and Erosion Test, ASTM D 2303.

13. The flame-retardant cable of claim 1, wherein the cable retains greater 75% of physical properties after 1,000 hours of sunlight exposure as measured in a Xenon Arc Weather-o-meter.

14. The flame-retardant cable of claim 1, wherein the insulative layer is translucent.

15. The flame-retardant cable of claim 1, wherein the cable further comprises a semi-conductive layer.

16. The flame-retardant cable of claim 15, wherein the semiconductive layer comprises one or more fluoropolymers.

17. The flame-retardant cable of claim 16, wherein the one or more fluoropolymers is selected from the group consisting of: ethylene propylene (FEP), polyvinylidene fluoride (PVDF), perfluoro alkoxy alkane (PFA) and ethylene tetrafluoroethylene (ETFE), or a mixture thereof.

18. The flame-retardant cable of claim 1, wherein the reaction product of one or more fluoropolymers in the insulative layer is a co-polymer of tetrafluoroethylene and hexafluoropropylene or a terpolymer of tetrafluoroethylene hexafluoropropylene and Perfluoropropylvinyl Ether.

19. A method of reducing the risk of forest fires comprising:
applying an insulative layer around a conductive element, wherein the insulative layer comprises one or more fluoropolymers or a reaction product thereof.

20. The method of claim 19, wherein the one or more fluoropolymers are selected from the group consisting of: fluorinated ethylene propylene (FEP), polyvinylidene fluoride (PVDF), perfluoro alkoxy alkane (PFA) and ethylene tetrafluoroethylene (ETFE); or a combination thereof.
